(19) United States
(12) Patent Application Publication
(10) Pub. No.: US 2024/0104532 A1
(43) Pub. Date: Mar. 28, 2024

(54) SYSTEMS AND METHODS FOR PROVISIONING TOKENS FOR MULTIPLE USERS TO A TOKEN STORAGE DEVICE

(71) Applicant: Mastercard International Incorporated, Purchase, NY (US)

(72) Inventors: Christopher T. Scholl, Manchester, MO (US); David Vorhies, Saint Charles, MO (US); Shawn Mehrhoff, Saint Ann, MO (US)

(21) Appl. No.: 18/535,861

(22) Filed: Dec. 11, 2023

Related U.S. Application Data
(63) Continuation-in-part of application No. 16/662,968, filed on Oct. 24, 2019, now Pat. No. 11,842,328.

(51) Int. Cl. G06Q 20/10; G06Q 20/20; G06Q 20/28; G06Q 20/40; G06Q 40/02

(52) U.S. Cl. CPC G06Q 20/108; G06Q 20/204; G06Q 20/28; G06Q 20/40145; G06Q 40/02; G06Q 20/385

(57) ABSTRACT

A token management computing system for provisioning at least one secure payment token for use in payment transactions is provided. The token management computing system includes a token storage device in communication with a plurality of user computing devices each associated with a respective user, and a token management (“TM”) server. The TM server is programmed to receive a token request for at least one token, generate, upon receiving the token request, the at least one token, wherein the at least one token includes at least one of i) a prepaid token including prepaid funds, ii) multiple tokens each associated with a different user, and iii) a budgeting token associated with a plurality of virtual budget accounts.

### CROSS REFERENCE TO RELATED APPLICATIONS

This application claims priority to and is a continuation-in-part of U.S. patent application Ser. No. 16/662,968 filed on Oct. 24, 2019, entitled “SYSTEMS AND METHODS FOR PROVISIONING A TOKEN TO A TOKEN STORAGE DEVICE”, which is hereby incorporated by reference in its entirety.

### BACKGROUND

The present application relates generally to secure token transmission from a user computing device to a token storage device, and more specifically, to a system and method for provisioning secure payment tokens to a token storage device for use in payment transactions.

On occasion, due to increasing security concerns, a cardholder may be wary of using his or her physical credit card or mobile device (e.g., a smartphone) to pay for in-store purchases at certain locations or merchants. For example, if the cardholder is shopping at a retail chain that has recently reported a big customer data breach, the cardholder may be apprehensive as to whether doing so will compromise their payment credentials. In another example, if the cardholder needs to make a purchase, but is at a large crowded event, such as a music festival, or is passing through a high crime area, the cardholder may be concerned of either losing their smartphone, purse, and/or wallet or having any of these items stolen.

It is well known that credit card scammers target point-of-sale (POS) terminals to steal cardholder data from, for example, magnetic stripes on traditional payment cards by using credit card skimmers. In order to circumvent the security concerns surrounding magnetic stripes, many payment cards are now embedded with security chips. However, as many payment cards are equipped with both magnetic stripes and security chips, credit card scammers are still targeting POS terminals to steal cardholder data from payment cards, even though a cardholder may dip their chip to pay for an in-store purchase. In addition to using credit card skimmers, scammers are known to use credit card shimmers, which unlike credit card skimmers, are placed inside the credit card slot to target customers who pay by dipping their chip-based card. Thus, it appears that credit card skimmers are continuously evolving to try and address anti-fraud security measures.

Newer forms of payment, such as payment with a mobile device using a digital wallet, use unique payment tokens, as opposed to credit card data. In payment tokenization, the customer's primary account number (PAN) is replaced with a stand-in token, which may be a series of randomly-generated numbers. Credit card encryption, on the other hand, does not replace the customer's PAN with a placeholder, but instead encrypts the cardholder data to disguise the PAN into an unreadable code. The code can be decrypted using an encryption key. Tokenization is generally cheaper, easier to use, and more secure than encryption, as in the case of a merchant security breach, meaningless tokens, rather than sensitive payment data is exposed. However, payment tokens are generally only available for use as in-store payments by using a mobile device with a digital wallet, and not where a physical payment card is used.

Accordingly, it is desirable to have a system that enables payment tokens to be used for in-store purchases without the use of mobile devices, and for a cardholder to further address the above security concerns by being able to establish customized controls for using each payment token.

### BRIEF DESCRIPTION

In one aspect, a token management computing system for provisioning at least one secure payment token for use in payment transactions is provided. The token management computing system includes a token storage device configured to communicate a payment token to a merchant point-of-sale terminal, wherein the token storage device is in communication with a plurality of user computing devices each associated with a respective user, and a token management (“TM”) server. The TM server includes a memory device for storing data, and at least one processor communicatively coupled to the memory device, the at least one processor programmed to receive, from at least one of the user computing devices, a token request for at least one token, generate, upon receiving the token request, the at least one token, wherein the at least one token includes at least one of i) a prepaid token including prepaid funds from the plurality of users, ii) multiple tokens each associated with a different user of the plurality of users, and iii) a budgeting token associated with a plurality of virtual budget accounts corresponding to the plurality of different users, transmit the at least one generated token to one or more of the user computing devices, and instruct the one or more of the user computing devices to transfer the at least one token to the token storage device for use at a physical merchant location.

In another aspect, a token storage device for communicating a payment token to a merchant point-of-sale terminal is provided. The token storage device includes a memory device, and at least one processor communicatively coupled to the memory device. The at least one processor is programmed to receive at least one token from at least one user computing device of a plurality of user computing devices each associated with a respective user, wherein the at least one token is generated by a token management (“TM”) server, and wherein the at least one token includes at least one of i) a prepaid token including prepaid funds from the plurality of users, ii) multiple tokens each associated with a different user of the plurality of users, and iii) a budgeting token associated with a plurality of virtual budget accounts corresponding to the plurality of different users, store the at least one received token in the memory, and transmit the at least one received token to the merchant point-of-sale terminal to facilitate completing a purchase transaction.

### BRIEF DESCRIPTION OF THE DRAWINGS

FIGS. 1-8 show example embodiments of the methods and systems described herein.

FIG. 1 is a flow diagram illustrating an example process for communicating a payment token to a token storage device using an example token management (“TM”) computing system.

FIG. 2 is a flow diagram illustrating a purchase transaction through a payment card processing network using the token storage device shown in FIG. 1.

FIG. 3 is an example purchase environment illustrating using a user computing device to load a token generated by the TM server onto the token storage device for use at a physical merchant location, as shown in FIG. 1.

FIG. 4 illustrates an example configuration of a token management (“TM”) server of the token management (“TM”) computing system, as shown in FIG. 1.

FIG. 5 is a diagram of components of one or more example computing devices that may be used in the token management (“TM”) computing system shown in FIG. 1.

FIG. 6 is a flow diagram illustrating an example token management (“TM”) computing system involving multiple users.

FIG. 7 is a flow diagram of one embodiment of a method for dynamically switching between tokens that may be used in the token management (“TM”) computing system shown in FIG. 6.

FIG. 8 is a flow diagram of one embodiment of a method for tracking funds spent from a combined payment account against a virtual budget account that may be used in the token management (“TM”) computing system shown in FIG. 6.

Like numbers in the Figures indicate the same or functionally similar components. Although specific features of various embodiments may be shown in some figures and not in others, this is for convenience only. Any feature of any figure may be referenced and/or claimed in combination with any feature of any other figure.

### DETAILED DESCRIPTION

The systems and methods described herein are directed to provisioning a secure payment token from a user computing device onto a token storage device for use at a physical merchant location. Specifically, payment tokens are generated for in-person transactions. The token storage device is a portable device such as, for example, a fob, puck, key chain, trinket, or card having rewritable data storage capabilities. In one example embodiment, the systems and methods may be performed by a token management (“TM”) server.

The token management (“TM”) computing system enables users to conduct token-based transactions using token storage devices for card present transactions. The TM computing system enables a user to set one or more token controls to define appropriate usage of a requested token. By enabling a user to set one or more token controls, such as a total spend limit associated with a token, the TM computing system facilitates fraud prevention. More specifically, the TM computing system facilitates fraud prevention by providing multiple layers of security to protect a user's payment credentials. Rather than simply encrypting a user's payment account number (PAN), the TM computing system is configured to generate temporary PANs on a per-transaction basis. The TM computing system is further configured to tokenize the temporary PAN (hereinafter referred to as “token”), and transmit this token to a user for use at a physical merchant location.

In the example embodiment, the TM computing system includes a user computing device (e.g., a mobile device) associated with a user, a token management (“TM”) server, a database, and a token storage device. The user computing device includes a digital wallet (e.g., mobile wallet, e-wallet) and an app (e.g., software application) provided by the TM server. The app is configured enable the user to activate the token storage device to load (e.g., communicate, transfer, transmit) a secure payment token onto the token storage device. The token storage device includes an embedded microchip configured to receive the payment token from the user computing device. The embedded microchip may be an EMV® chip (EMV is a registered trademark of EMVCo, LLC, Foster City, CA). In the example embodiment, the token storage device does not have a magnetic stripe. In some embodiments, the embedded microchip is configured to provide an additional layer of security by encrypting the received payment token. Thus, in these embodiments, the token storage device communicates an encrypted payment token to a merchant (e.g., a merchant point-of-sale (POS) terminal) during an in-store payment transaction.

During an in-store payment transaction, the token storage device is configured to communicate the secure payment token to the merchant (e.g., the merchant point-of-sale terminal) by tapping or dipping the token storage device. The merchant POS terminal may be configured to read EMV chips, and enable contactless payments, via, for example, Near Field Communication (NFC).

To activate the token storage device and load a secure payment token thereon, a user submits a token request to the TM server via the app. When the user accesses the app on the user's user computing device, the app may prompt the user to select a payment account number (e.g., PAN) from the user's digital wallet. This payment account number may be referred to herein as “original PAN,” and “funding account number.” The token request further includes one or more token controls. In the example embodiment, the token request includes a total spend limit (e.g., an amount of value) as a token control. Additional token controls may include a designated period of time associated with using the requested token. For example, the user may set an expiration date of one week from the date of receiving the token. In this example, if the user does not use the requested token within the selected time frame, the requested token automatically deactivates, and cannot be used as payment in an in-store payment transaction. In other embodiments, the TM server may automatically apply an expiration date to the requested token as a security precaution if a user does not provide an expiration date. For example, the TM server may deactivate the payment token one month or a year from the requested date if the user has not loaded the requested token onto the token storage device and/or has not used the requested token within this allotted time frame.

Additional token controls may also include a number of transactions associated with the requested token. In some embodiments, the user can request a token for a single transaction (e.g., one-time token, single-use token). In another embodiment, the user can request a token for multiple transactions (e.g., multi-use token). In this embodiment, the user may be prompted to input a number of transactions for the requested multi-use token. For example, the token request may specify (i) a total spend limit of $50 and (ii) a transaction limit of four payment transactions to apply to a requested token. In one embodiment, the user may designate specific merchant categories for making purchases using the requested token. In this embodiment, the TM server may provide a list of merchant categories or otherwise prompt the user to input specific merchant categories to limit where the requested token can be used.

For example, the token request may specify that transactions associated with the requested token are to be limited to grocery stores and supermarkets as well as gas/service stations. In another embodiment, the TM server may enable the user to specify merchant categories for where the requested token may not be used. For example, the token request may include a spend control specifying that the requested token can be used to make purchases in any merchant category except merchant categories associated with package stores, beer, wine, and liquor. In these embodiments, a parent submitting a token request to enable their teenage child to use the token storage device may apply additional token controls, such as those discussed above, to limit merchant locations where the child can use the token storage device. In other embodiments, the TM server may enable a user to provide, in the token request, a physical merchant location, a retail chain, a restaurant chain, or an address (e.g., airport) at which the requested token may be used.

By enabling a user to set, at the outset, token controls associated with a requested token, the TM server enables a user to make purchases at physical merchant locations where security may be compromised (e.g., credit card skimmers, camera cover PIN stealers) without putting the credit card holder's information at risk. For example, if a user's mobile device is an expensive smart phone, and the user is traveling through a high-crime area known for reoccurring issues with card skimmers, the user may be apprehensive about using his or her smart phone and/or physical credit card to conduct a payment transaction. In this example, the user may access the app to transmit a token request to the TM server. The user can designate, in the token request, a total spend limit associated with the token.

In this example, the user can use his or her mobile device to load, onto the token storage device, a secure payment token for one-time use at a gas station before the user leaves his or her vehicle. The user may specify, in the token request, a total spend limit of $30 to be applied. The user may then safely put away his or her expensive smart phone in the vehicle, and proceed to use the token storage device at a card reader at the gas pump or inside the gas station.

In some embodiments, a token storage device may store a token associated with multiple users and/or multiple tokens each associated with a different user.

For example, in one embodiment, token storage device stores a token that uses prepaid funds from multiple users. This allows the multiple users to each contribute to a total spending limit loaded onto token. For example, two users may plan on attending an event (e.g., a concert) together or taking a trip together, and may both want to conduct one or more purchase transactions at the event or trip using the token storage device.

In another embodiment, a token is associated with a single payment account shared by multiple users. For example, users may establish a shared payment account (e.g., through an issuing bank), and each contribute funds to the shared payment account. To activate the token storage device, one of thus users submits a token request with a PAN identifying the shared payment account. In response, a token associated with the received PAN is generated and loaded onto the token storage device.

In yet another embodiment, instead of a token being associated with one or more payment accounts, funds may be directly loaded onto the token. For example, a first user may electronically transfer first funds from a first payment account onto the token, and a second user may electronically transfer second funds from a second payment account onto the token. When purchase transactions are performed, instead of the token being mapped to a payment account, the appropriate funds are simply electronically transferred from the token, with the token effectively functioning as a prepaid device.

Further, in some embodiments, a token storage device includes a biometric sensor (e.g., a fingerprint sensor, a facial recognition sensor, a retinal sensor, and/or a voice sensor). The biometric sensor facilitates identifying and/or authenticating a user of the token storage device, as described herein. For example, during a purchase transaction, candidate biometric data of a user presenting the token storage device may be compared with baseline biometric data of an authorized user to determine whether or not to proceed with a purchase transaction.

In other embodiments involving multiple users, multiple tokens are stored on a token storage device, with each token associated with a different user. For example, the token storage device may include a first token that is linked to a first payment account of a first user, and a second token that is linked to a second payment account of a second user. During a purchase transaction, the token storage device is capable of dynamically switching between using the first and second tokens based on which user is using the token storage device for the purchase transaction.

In yet another embodiment involving multiple users, a token stored on a token storage device is associated with a plurality of virtual budget accounts, each virtual budget account associated with a different user. This enables tracking spending budgets for each user over the duration of a trip or event, and facilitates settling up between users after the conclusion of the trip or event, as described herein.

The technical effects achieved by the systems and methods described herein include enabling secure payment tokens to be used for in-store purchase transactions without requiring a user computing device, and providing multiple layers of security on a per-transaction basis, thereby providing heightened protection with respect to a credit card holder's payment credentials. By furnishing a user with a token storage device that is configured to store tokens as opposed to the user's personal identifying information, such as a personal account number (PAN), the credit card holder's payment credentials are protected even in the event the token storage device is lost or stolen. Further, by enabling a user to establish token controls for each requested token on a per-transaction basis, the TM computing system not only generates customized payment tokens for use by the user, but also monitors each transaction for fraud in accordance with a variety of user-set token controls. The TM computing system described herein is configured to process token requests in real time (or near real time) to provision secure payment tokens to the user in real time.

The methods and systems directed to the token management computing system described herein may be implemented using computer programming or engineering techniques including computer software, firmware, hardware or any combination or subset thereof, wherein the technical effect may be achieved by performing at least one of the following steps: (a) receiving, from at least one of a plurality of user computing devices, a token request for at least one token, (b) generating, upon receiving the token request, at least one token, wherein the at least one token includes at least one of i) a prepaid token including prepaid funds from the plurality of users, ii) multiple tokens each associated with a different user of the plurality of users, and iii) a budgeting token associated with a plurality of virtual budget accounts corresponding to the plurality of different users, (c) transmitting the at least one generated token to one or more of the user computing devices, and (d) instructing the one or more of the user computing devices to transfer the at least one token to a token storage device for use at a physical merchant location.

In one embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality. The following detailed description illustrates embodiments of the disclosure by way of example and not by way of limitation. It is contemplated that the disclosure has general application to providing a token management (“TM”) computing system for provisioning secure payment tokens to a token storage device for use in card present payment transactions between customers and merchants, thus providing an alternative to using a mobile device or an issued payment card for in-store purchases.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, a card that is part of a digital wallet, and/or any other device that may hold payment account information, such as mobile phones, smartphones, personal digital assistants (PDAs), key fobs, and/or computers. Each type of transaction card can be used as a method of payment for performing a transaction. As used herein, the term “payment account” is used generally to refer to the underlying account associated with the transaction card.

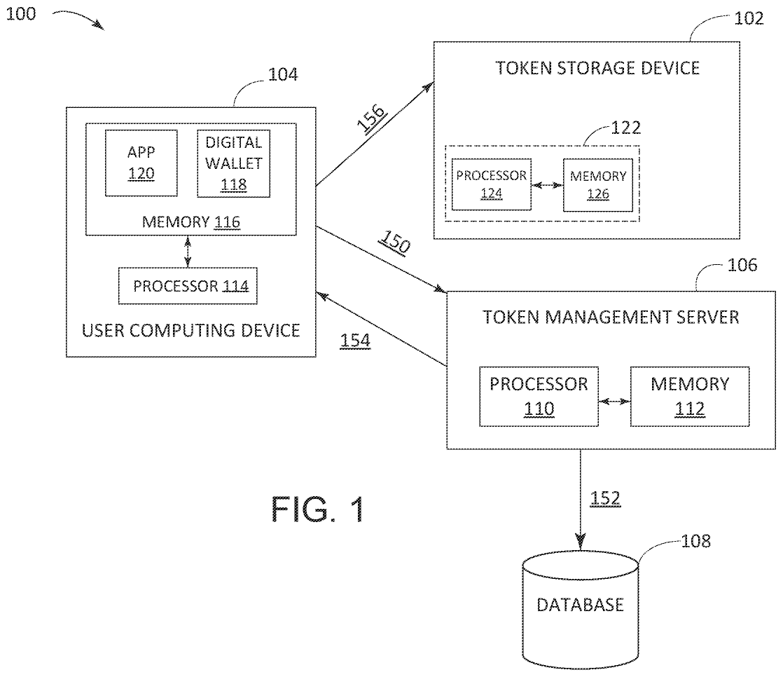

FIG. 1 is a flow diagram illustrating an example process for provisioning a secure payment token from a user computing device 104 to a token storage device using a example token management (“TM”) computing system 100. In particular, FIG. 1 depicts the flow of data for activating a token storage device 102 by utilizing user computing device 104 associated with a user. In the example embodiment, TM computing system 100 includes user computing device 104, a token management (“TM”) server 106, a database 108, and a token storage device 102. TM server 106 includes at least one processor 110 in communication with a memory 112. Additionally or alternatively, memory 112 may include database 108 and/or a database server (not shown).

In the example embodiment, user computing device 104 is in communication with token management server 106 and token storage device 102. User computing device 104 includes at least one processor 114 in communication with a memory 116. Memory 116 stores a digital wallet (e.g., mobile wallet, e-wallet) 118 and an app 120 (e.g., software application) provided to user computing device 104 by TM server 106. In the example embodiment, app 120 is in communication with digital wallet 118. App 120 is configured to enable a user to activate token storage device 102. More specifically, processor 114 of user computing device 104 executes app 120 to communicate (e.g., load, transfer, transmit) a secure payment token 156 received from TM server 106 to token storage device 102. In the example embodiment, payment token 156 is a tokenized temporary PAN that is generated by TM server 106 for a single transaction. In some embodiments, secure payment token 156 may be for a limited number of transactions specified by the user.

Token storage device 102 includes an embedded microchip (e.g., integrated circuit chip) 122. Embedded microchip 122 includes at least one processor 124 in communication with a memory 126. In the example embodiment, microchip 122 is configured to receive one or more payment tokens 156 from user computing device 104 and securely store the token(s) 156 within memory 126 of token storage device 102. Token storage device 102 may also have a radio frequency (RFID) antenna to enable contactless payments via, for example, near field communication (NFC). Token storage device 102 may take the form of a physical payment card. In other embodiments, token storage device 102 may take the form of a key fob, puck, key chain, trinket, or other portable device.

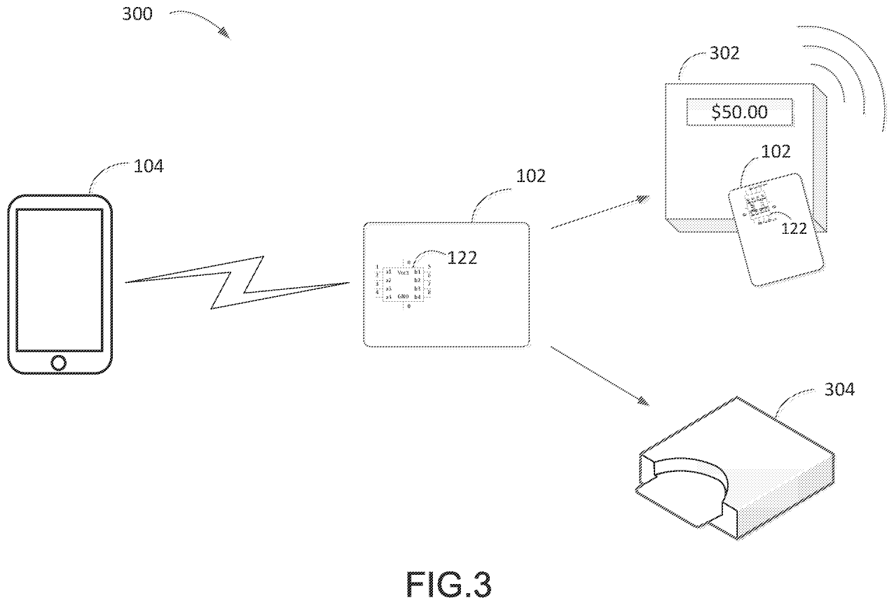

In the example embodiment, embedded microchip 122 is configured to securely store received payment token 156 and communicate token 156 to a merchant POS terminal, such as POS terminals 302 and 304 (shown in FIG. 3) as payment during a payment transaction at a merchant location. In some embodiments, microchip 122 is configured to provide an additional layer of security by encrypting payment token 156. In these embodiments, microchip 122 stores encrypted payment token 156 in memory 126, and transmits encrypted payment token 156 to a merchant POS terminal, such as POS terminals 302 and 304 when the user initiates a payment transaction at the merchant location.

To activate token storage device 102 for use at a physical merchant location, a user submits a token request 150 to TM server 106 via app 120. In the example embodiment, token request 150 includes a payment account number (PAN) and a spend limit (e.g., an amount of value) to apply to a requested token 156. App 120 may prompt the user to select a PAN stored in digital wallet 118. Token request 150 may include additional information, including, but not limited to, a device identifier associated with user computing device 104, a user identifier registered with app 120 (such as a user email address and/or user account identifier registered with app 120), a time stamp (e.g., date and time) associated with token request 150, and location data associated with user computing device 104 at the time of transmitting token request 150 (e.g., geographic coordinates, geographic area, zip code).

In addition to a spend limit, token request 150 may include additional token controls (e.g., user specified conditions, parameters, spend controls) to apply to requested token 156. Additional spend controls may include a designated period of time associated with using requested token 156. The user may provide an expiration date and/or time to apply to requested token 156. In other embodiments, TM server 106 may automatically apply an expiration date to requested token 156 as a security precaution if a user does not provide an expiration date. Additional token controls may also include a limited number of transactions associated with requested token 156, such as a single-use token or a multi-use token. Token controls may further include one or more merchant categories.

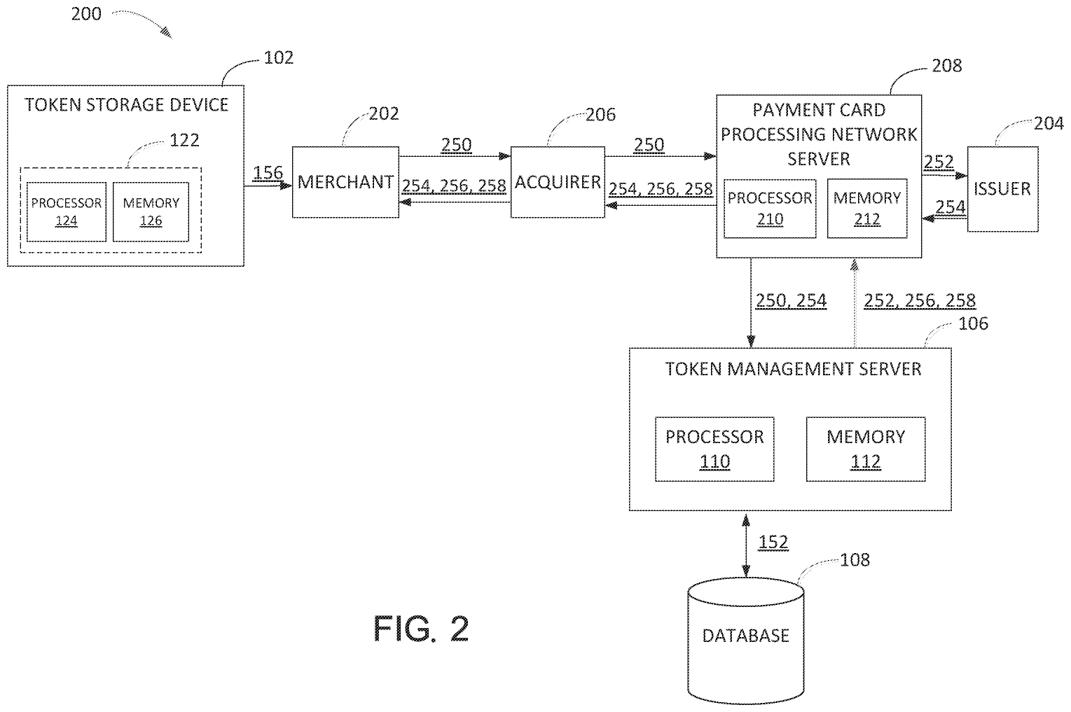

In the example embodiment, TM server 106 receives token request 150 from user computing device 104, and proceeds to generate token 156. More specifically, TM server 106 generates token 156 by (i) generating a temporary PAN associated with the token request 150, and (ii) tokenizing the temporary PAN. Thus, by generating a temporary PAN and further tokenizing the temporary PAN, TM server 106 provides layers of security in the event a merchant is hacked and customer payment information is compromised. In some embodiments, TM server 106 validates the original PAN (e.g., funding account number) received in token request 150 with the user's credit card issuer, such as issuer 204 (shown in FIG. 2). In these embodiments, TM server 106 proceeds to generate token 156 only after validating the PAN with the user's issuer.

After generating token 156, TM server 106 stores token information 152 regarding generated token 156 in database 108. In particular, token information 152 includes data regarding the relationship between the user and generated token 156 in database 108. In the example embodiment, the spend controls provided by the user in token request 150 are stored in database 108 and associated with generated token 156, such that the spend controls may be referenced and applied by TM server 106 when the user initiates a payment transaction using token storage device 102. TM server 106 may generate a user profile that includes information received in token request 150 as well as generated token 156. The user profile can be stored in database 108. Information stored at database 108 may also include a device identifier associated with token storage device 102.

In the example embodiment, TM server 106 subsequently transmits a token response message 154 to user computing device 104. In the example embodiment, token response message 154 includes generated token 156 as well as instructions regarding provisioning token 156 to token storage device 102. App 120 may notify the user of received token 156. For example, app 120 may be programmed to display a notification on user computing device 104 indicating that token 156 has been received on user computing device 104. App 120 stores token 156 in memory 116 of user computing device 104.

In the example embodiment, user computing device 104 extracts token 156 from token response message 154 and transmits token 156 to token storage device 102 in accordance with the instructions received from TM server 106 in token response message 154. TM server 106 may instruct user computing device 104 to automatically (without further input from user) transfer token 156 to token storage device 102. In further embodiments, TM server 106 may instruct user computing device 104 to transfer token 156 to token storage device 102 upon receiving a user input from the user. For example, app 120 may be programmed to prompt the user to select a “transfer token to card” option. In this example, user computing device 104 provisions token 156 to token storage device 102 upon receiving this user input. In these embodiments, token 156 may be stored in memory 116 of user computing device 104 for a limited period of time (e.g., a couple of days) until the user initiates transfer of token 156 from user computing device 104 to token storage device 102.

Upon transferring token 156 to token storage device 102, token 156 is stored in memory 126 of embedded microchip 122. In some embodiments, upon receiving token 156 from user computing device 104, token storage device 102 encrypts token 156 and stores encrypted token 156 in memory 126 of embedded microchip 122. This encryption (e.g., cryptography) process is provided by embedded microchip 122 as an additional security measure to further encrypt the tokenized temporary PAN (e.g., the token) in the event of a customer data breach at one or more merchant locations where token storage device 102 is used. Once token 156 is stored in memory 126 of embedded microchip 122, token storage device 102 is ready to be used at a physical merchant location.

FIG. 2 is a flow diagram illustrating an example purchase transaction 200 through a payment card processing network using token storage device 102 (shown in FIG. 1). FIG. 3 is an example purchase environment 300 illustrating using user computing device 104 to load a token generated by TM server 106 onto token storage device 102 for use by a customer at a physical merchant location (all shown in FIG. 1). In the example embodiment, a user loads a token, such as token 156 (shown in FIG. 1) onto token storage device 102 using user computing device 104, as discussed above with respect to FIG. 1.

User computing device 104 may communicate token 156 to token storage device 102 via wireless communication, for example, via an IEEE 802.11 wireless local area network. User computing device 104 may communicate token 156 to token storage device 102 using a mobile phone network associated with user computing device 104, such as Global System for Mobile communications (GSM), 3G, 4G Bluetooth or other mobile data network (e.g., Worldwide Interoperability for Microwave Access (WIMAX)). The user may or may not be the customer using token storage device 102 to make a purchase at the physical merchant location. For example, the customer may be an authorized credit card user or a family member (e.g., child, spouse, relative) associated with the user.

In the example embodiment, the customer uses token storage device 102 during checkout to communicate a token 156 as payment to a merchant 202 during a payment transaction. Token storage device 102 is configured for use at a physical merchant location equipped with a point-of-sale (POS) terminal capable of processing chips, such as embedded microchip 122. As shown in FIG. 3, merchant 202 can have a contactless POS terminal 302, which enables the user to pay via NFC by tapping token storage device 102 on POS terminal 302. Additionally or alternatively, merchant 202 may have a contact POS terminal 304, which enables the user to pay by dipping token storage device 102 in a chip reader slot available on contact POS terminal 304.

In purchase environment 300, as shown in FIG. 3, token storage device 102 takes the form of a payment card. In purchase environment 300, token storage device 102 does not include a magnetic stripe, as seen in traditional payment cards, as magnetic stripes make it easier to put customer card information at risk. Rather, token storage device 102 only has embedded chip 122. Embedded chip 122 may be an EMV chip. In these embodiments, contactless POS terminal 302 and contact POS terminal 304 are equipped with EMV card readers.

Payment card processing network server 208 is part of the payment card processing network, such as the Mastercard® credit card payment network. The Mastercard® payment processing network is a proprietary communications standard promulgated by Mastercard International Incorporated® for the exchange of financial transaction data between financial institutions that are registered with Mastercard International Incorporated®. (Mastercard is a registered trademark of Mastercard International Incorporated located in Purchase, New York). In the payment card processing network, an issuer 204, typically a financial institution such as an issuing bank, issues a payment card, such as a credit card account or a debit card account, to a customer, who uses the payment card to tender payment for a purchase from a merchant 202. To accept payment with the payment card, merchant 202 must normally establish an account with a financial institution that is part of the financial payment system. This financial institution is usually called the “merchant bank” or the “acquiring bank” or simply “acquirer” 206.

In the example embodiment, merchant 202 receives a token 156 (e.g., the tokenized temporary PAN) as the customer's payment information when the customer uses token storage device 102 for payment, rather than the customer's real PAN issued by issuer 204. Merchant 202 subsequently transmits an authorization request message 250 including token 156 to acquirer 206 over the payment card processing network. More specifically, when the user tenders payment for a purchase with token storage device 102, merchant 202 requests authorization from acquirer 206 for the amount of the purchase. The request is performed through the use of a POS terminal, as described above, which reads the user's payment information, the token, from embedded chip 122, and communicates electronically with the transaction processing computers of acquirer 206. Alternatively, acquirer 206 may authorize a third party to perform transaction processing on its behalf. In this case, the POS terminal will be configured to communicate with the third party. Such a third party is usually called a “merchant processor,” an “acquiring processor,” or a “third party processor.”

Acquirer 206 transmits authorization request message 250 to payment card processing network server 208. In the example embodiment, payment card processing network server 208 is associated with and/or integral to the payment card processing network. In the example embodiment, authorization request message 250 is formatted according to ISO 8583 network messaging protocol or the equivalent messaging protocol used by the payment card processing network, thus ensuring that token management computing system 100 functions in concert with legacy payment card processing network systems. In the example embodiment, payment card processing network server 208 recognizes that authorization request message 250 contains a token, such as generated token 156, instead of a PAN, and subsequently routes authorization request message 250 to TM server 106. For example, payment card processing network server 208 checks the PAN field of authorization request message 250 to determine if the PAN can be routed to issuer 204. In this example, instead of finding a series of numbers that correspond to a PAN in the PAN field, payment card processing network server 208 may determine that the series of numbers in the PAN field correspond to a token. Payment card processing network server 208 may subsequently route authorization request message 250 to TM server 106 instead of directly onto issuer 204.

Payment card processing network server 208 includes at least one processor 210 for executing instructions and a memory 212 in communication with the at least one processor 210 for storing the executable instructions. Processor 210 may include one or more processing units (e.g., in a multi-core configuration). Memory 212 is any device allowing information such as executable instructions and/or other data to be stored and retrieved. Memory 212 may include one or more computer-readable media. Processor 210 is operatively coupled to a communication interface (not shown) such that payment card processing network server 208 is capable of communicating with remote computing devices, such as acquirer 206, issuer 204, TM server 106, or another server computing device. Processor 210 also is operatively coupled to a database interface (not shown) such that payment card processing network server 208 is capable of communicating with a database.

In the example embodiment, upon determining that authorization request message 250 contains token 156, payment card processing network server 208 transmits token 156 in authorization request message 250 to TM server 106. TM server 106 is configured to perform PAN mapping, and translate token 156 to the funding account number (e.g., original PAN issued by issuer 204) as recognized by issuer's 204 computing systems. More specifically, TM server 106 uses token 156 from authorization request message 250 to retrieve token information 152 stored in database 108 (all shown in FIG. 1). In particular, TM server 106 retrieves token information 152, including the funding account number and the spend controls provided by user in token request 150 (as shown in FIG. 1). In some embodiments, TM server 106 uses token 156 to retrieve, from database 108, a user profile associated with the user.

As discussed above, in the example embodiment, the spend controls include at least a transaction amount limit associated with the token. TM server 106 applies each of the retrieved spend controls to the transaction identified in authorization request message 250 to determine whether all of the predefined spend controls have been met. For example, if in token request 150, the user set the transaction amount limit to $50 for a one-time use token, TM server 106 is configured to apply the spend controls to the transaction, and determine whether to (i) forward authorization request message 250 onto issuer 204 or (ii) deny authorization and decline the transaction.

In the above example, if the total transaction amount is less than or equal to $50, and all the other spend controls (if any) are met, TM server 106 is configured to replace token 156 in the PAN field of authorization request message 250 with the original PAN. In the example embodiment, when TM server 106 determines that all of the spend controls are met, TM server 106 transmits an updated authorization request message 252, including the original PAN, to issuer 204 for authorization. In some embodiments, both the original PAN as well as token 156 are included in updated authorization request message 252 transmitted to issuer 204. In the example embodiment, issuer 204 transmits an authorization response message 254 indicating approval of the subject payment transaction to payment card processing network server 208. In the example embodiment, authorization response message 254 is formatted according to ISO 8583 network messaging protocol or the equivalent messaging protocol used by the payment card processing network.

In some embodiments, payment card processing network server 208 recognizes that authorization response message 254 is associated with a token, such as generated token 156, and transmits authorization response message 254 to TM server 106. In these embodiments, TM server 106 performs a look up in database 108 to find the token that corresponds to the original PAN for this particular transaction. TM server 106 subsequently replaces the PAN with the token in authorization response message 254 and transmits an updated authorization response message 258 to acquirer 206 through payment card processing network server 208. In embodiments where authorization response message 254 includes both the original PAN and the token, TM server 106 removes the PAN from authorization response message 254. In other embodiments, TM server 106 can update database 108 to include details regarding authorization response message 254, specifying that issuer 204 indicated approval of the transaction.

After performing any suitable processing operations, payment card processing network server 208 subsequently transmits authorization response message 254 or updated authorization response message 258 to acquirer 206, and the available credit line or available account balance of the cardholder account is decreased. Acquirer 206 transmits transaction approval 254, 258 directly to merchant 202 (such as to a merchant POS terminal), notifying merchant 202 that the transaction has been authorized. Merchant 202 subsequently provides to the customer, the good or service purchased by the customer to complete the payment transaction. In the example embodiment, to minimize exposure of the funding account number at each stage of the processing the payment transaction, authorization response message 254 does not include the funding account number (e.g., the original PAN). Rather, where applicable, authorization response message 254 includes reference to the token generated by TM server 106.

In events where TM server 106 determines that one or more of the spend controls are not met, TM server 106 rejects authorization of the transaction. More specifically, TM server 106 automatically transmits, to acquirer 206, a transaction decline message 256 declining the transaction. For example, in the event someone steals token storage device 102 and attempts to use it at a physical merchant location, TM server 106 can immediately deny the transaction by applying one or more spend controls stored in database 108. In this example, the person who stole token storage device 102 attempts to purchase an item for $1000 at an electronics store. However, the spend control defines (i) a transaction amount limit of $30 for a (ii) one-time transaction at a gas station (iii) located within a specific zip code. Accordingly, TM server 106 can determine, from applying the spend controls to the attempted purchase transaction, that the transaction should be denied because the transaction (a) exceeds the $30 spend limit, (b) is for a good or service associated with an unauthorized merchant category, and (c) is outside the zip code set by the user.

In the example embodiment, TM server 106 is configured to automatically deny transactions that do not meet all of the predefined spend controls without forwarding a message, such as updated authorization request message 252 to issuer 204. Acquirer 206 transmits transaction decline message 256 to merchant 202 (such as to a merchant POS terminal), notifying merchant 202 that the transaction has been declined. In some embodiments, upon denying a transaction, TM server 106 generates and transmits a notification message to user computing device 104 to alert the user. In some embodiments, TM server 106 updates database 108 to include details regarding transaction decline message 256, specifying denial of authorization and the reasons for doing so.

Normally, a charge is not posted immediately to the cardholder account because bankcard associations, such as Mastercard International Incorporated®, have promulgated rules that do not allow a merchant to charge, or “capture,” a transaction until goods are shipped or services are delivered. When merchant 202 ships or delivers the goods or services, merchant 202 captures the transaction by, for example, appropriate data entry procedures on the POS terminal. If the customer cancels a transaction before it is captured, a “void” is generated. If the customer returns goods after the transaction has been captured, a “credit” is generated. Payment card processing network server 208 and/or issuer 204 stores the transaction data, such as a category of merchant, a merchant identifier, a location where the transaction was completed, amount of purchase, date and time of transaction in a database.

A clearing process transfers transaction data related to the purchase among the parties to the transaction, such as acquirer 206, payment card processing network server 208, and issuer 204. No money is exchanged during the clearing process. Clearing involves the exchange of data required to identify the cardholder account such as the account number, expiration date, billing address, amount of the sale, and/or other transaction identifiers that may be used to identify the transaction. Along with this data, banks in the United States also include a bank network reference number, such as the Banknet Reference Number used by Mastercard International Incorporated®, which identifies that specific transaction. When issuer 204 receives this data, it posts the amount of sale as a draw against the available credit of the cardholder account and prepares to send payment to the acquirer 206.

After a transaction is captured, the transaction is settled between merchant 202, acquirer 206, and issuer 204. Settlement refers to the transfer of financial data or funds between the merchant's account, acquirer 206, and issuer 204 related to the transaction. Usually, transactions are captured and accumulated into a “batch,” which is settled as a group. More specifically, a transaction is typically settled between issuer 204 and payment card processing network server 208, and then between payment card processing network server 208 and acquirer 206, and then between acquirer 206 and merchant 202.

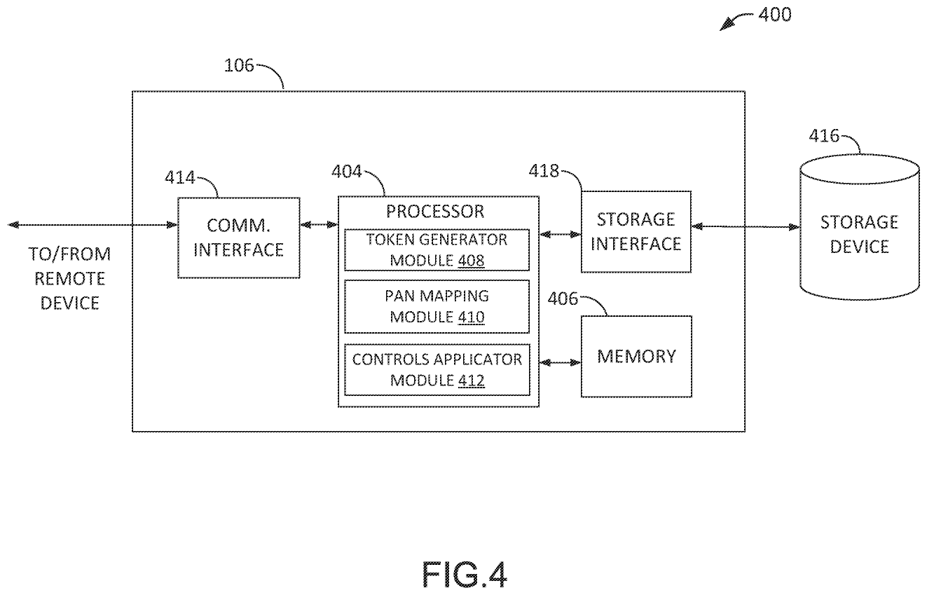

FIG. 4 illustrates an example configuration 400 of a token management (TM”) server 106 (shown in FIG. 1) in accordance with one embodiment of the present disclosure. TM server 106 includes a processor 404 for executing instructions. Instructions may be stored in a memory area 406, for example. Processor 404 may include one or more processing units (e.g., in a multi-core configuration) configured to generate a secure payment token for use on a token storage device 102 (both shown in FIG. 1).

In the exemplary embodiment, processor 404 is operable to execute modules, such as token generator module 408, PAN mapping module 410, and controls applicator module 412. Modules 408, 410, and 412 may include specialized instruction sets and/or coprocessors. In the example embodiment, token generator module 408 is utilized to generate one or more secure payment tokens in accordance with a token request, such as token request 150 (shown in FIG. 1) submitted by a user. In the example embodiment, mapping module 410 is utilized to map a token, such as token 156 back to the original PAN for which generated token 156 corresponds to (all shown in FIG. 2). Mapping module 410 may be utilized to retrieve token information 152 associated with token request 150 from database 108 to identify the original PAN (e.g., the funding account number) issued by issuer 204 (all shown in FIG. 2). In the example embodiment controls applicator module 412 is utilized to apply the spend controls associated with token 156 to the transaction data included in authorization request message 150. Controls applicator module 412 enables TM server 106 to determine whether to either (i) update authorization request message 150 with the original PAN and transmit the message to issuer 204 for approval, or (ii) decline the transaction, and transmit transaction decline message 256 to acquirer 206 via payment card processing network server 208 (all shown in FIG. 2).

Processor 404 is operatively coupled to a communication interface 414 such that TM server 106 is capable of communicating with a remote device such as one or more user computing devices 104 (shown in FIG. 1). For example, communication interface 414 may receive a token request, such as token request 150 from user computing device 104, requesting for a one-time use token to load onto token storage device 102 (all shown in FIG. 1).

Processor 404 may also be operatively coupled to a storage device 416. Storage device 416 is any computer-operated hardware suitable for storing and/or retrieving data. For example, database 108 may be implemented on storage device 416. In some embodiments, storage device 416 is integrated in TM server 106. For example, TM server 106 may include one or more hard disk drives as storage device 416. In other embodiments, storage device 416 is external to TM server 106 and may be accessed by a plurality of server computing devices. For example, storage device 416 may include multiple storage units such as hard disks or solid state disks in a redundant array of inexpensive disks (RAID) configuration. Storage device 416 may include a storage area network (SAN) and/or a network attached storage (NAS) system.

In some embodiments, processor 404 is operatively coupled to storage device 416 via a storage interface 418. Storage interface 418 is any component capable of providing processor 404 with access to storage device 416, such that PAN mapping module 410 and controls applicator module 412 are capable of communicating with database 108 (shown in FIG. 1). Storage interface 418 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 404 with access to storage device 416.

Memory area 406 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are for example only, and are thus not limiting as to the types of memory usable for storage of a computer program.

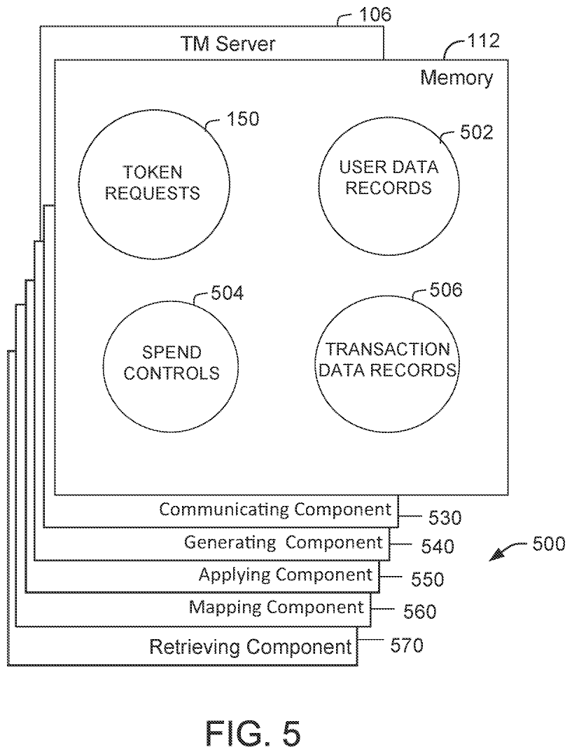

FIG. 5 depicts a diagram of components 500 of one or more example computing devices, such as TM server 106 that may be used in token management (“TM”) computing system 100 (all shown in FIG. 1). TM server 106 includes memory 112 configured to store various information which may be obtained from communication with, for example, database 108 and user computing device 104 (shown in FIG. 1). Memory 112 may be coupled with several separate components within TM server 106 which perform specific tasks. In the illustrated embodiment, memory 112 is divided into a plurality of sections and stores, including but not limited to, token requests 150, token data records 502, spend controls 504, and transaction data records 506.

With reference to FIGS. 1-4, in the example embodiment, components 500 include a communicating component 530 configured to receive token requests 150 from user computing devices 104, and transmit token response messages 154 containing tokens 156 to user computing devices 104. Communication component 530 is further configured to receive tokens in authorization request messages 250 from payment card processing network server 208, and transmit updated authorization request messages 252 and transaction decline messages 256.

Components 500 further include a generating component 540 configured to generate tokens, such as tokens 156. Generating component 540 is further configured to generate user notifications and alerts. Components 500 also include an applying component 550 configured to apply spend controls 504 received in token requests 150 to transactions using generated tokens 156. Spend controls 504 include, for example, transaction amount limits and merchant categories associated with each generated token 156. Components 500 also include a mapping component 560 configured to identify the original PAN (e.g., funding account number) associated with token 156. TM server 106 may utilize mapping component 560 to retrieve token requests 150 and/or user data records 502 to map token 156 to its original PAN. User data records 502 include user information, such as a device identifier associated with token storage device 102, a user identifier registered with TM server 106, a user email address and/or contact information registered with TM server 106, historical data detailing the number of times a user associated with a specific user identifier submitted token requests 150 within a period of time, and historical transaction information detailing merchant locations and/or merchant categories at which a user's requested tokens 156 were used.

Components 500 may further include a retrieving component 570 to retrieve token information 152, token requests 150, spend controls 504, and user data records 502 from database 108 to generate tokens and apply spend controls 504 to transaction data in authorization request messages 250. In some embodiments, TM server 106 may utilize retrieving component 570 to retrieve transaction data records 506 associated with tokens 156 to determine a pattern of token usage associated with a user and/or to transmit notifications to the user. Transaction data records 506 include data associated with transaction approvals and transaction declines associated with tokens 156. Transaction data records 506 may include details regarding the reasons for declining a token transaction. TM server 106 may utilize this information to generate notification/alert messages to transmit to a user.

### Provisioning One or More Tokens for Multiple Users

In some embodiments, a token storage device (such as token storage device 102 (shown in FIG. 1-3) may store (and enable use of) a token associated with multiple users and/or multiple tokens each associated with a different user.

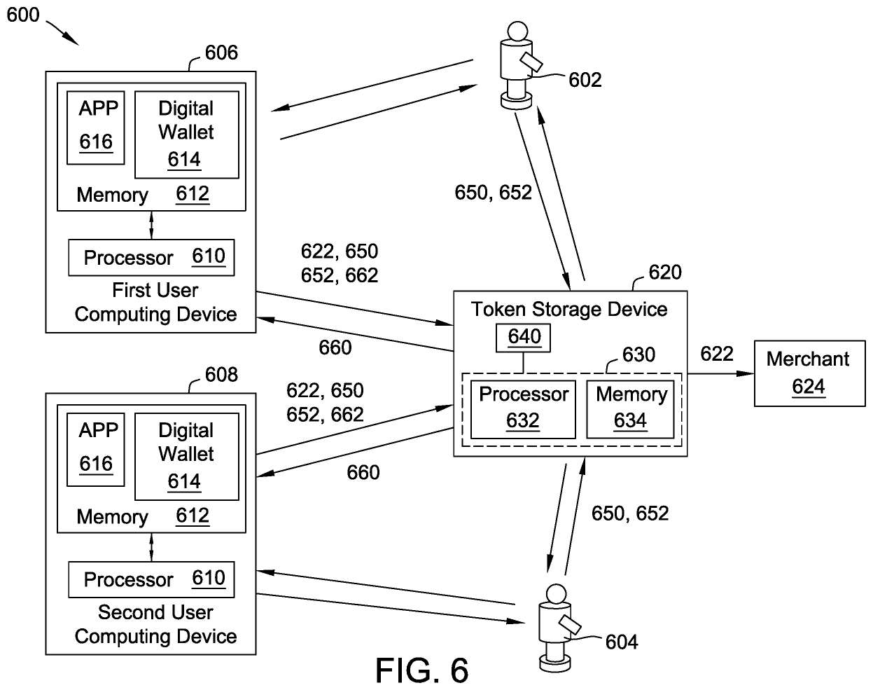

For example, FIG. 6 is a flow diagram illustrating an example TM computing system 600 involving multiple users (e.g., multiple cardholders). In this embodiment, a first user 602 and a second user 604 are shown. However, those of skill in the art will appreciate that any suitable number of users may participate in TM computing system 600.

A first user computing device 606 is associated with first user 602, and a second user computing device 608 is associated with second user 604. Similar to user computing device 104 (shown in FIG. 1), each of first and second user computing devices 606 and 608 includes a processor 610 in communication with a memory 612 storing a digital wallet 614 (e.g., mobile wallet, e-wallet) and an app 616 (e.g., a software application).

First and second user computing device 606 and 608 are in communication with a token storage device 620, such as token storage device 102 (shown in FIGS. 1-3). In the example embodiment, app 616 is in communication with digital wallet 614. App 616 is configured to enable the associated user to control and manage operation of token storage device 620, as described herein. More specifically, for each user computing device 606 and 608, processor 610 may execute app 616 to communicate (e.g., load, transfer, transmit) a secure payment token 622 to token storage device 620 and/or control operation of secure payment token 622. Similar to token 156 (shown in FIGS. 1 and 2), secure payment token 622 may be received at user computing devices 606 and 608 from a TM server (such as TM server 106 (shown in FIGS. 1 and 2).

Similar to token storage device 102, token storage device 620 includes an embedded microchip 630 (e.g., an integrated circuit chip). Embedded microchip 630 includes at least one processor 632 in communication with a memory 634. In the example embodiment, microchip 630 is configured to receive one or more payment tokens 622 from user computing devices 606 and 608 and securely store the token(s) 622 within memory 634 of token storage device 620. Token storage device 620 may also have a radio frequency (RFID) antenna to enable contactless payments via, for example, near field communication (NFC). Token storage device 620 may take the form of a physical payment card or any other suitable device (e.g., a key fob, a key chain, a puck, a trinket, etc.).

In this embodiment, token storage device 620 includes a biometric sensor 640 in communication with microchip 630. Biometric sensor 640 may include, for example, a fingerprint sensor, a facial recognition sensor, a retinal sensor, and/or a voice sensor. Those of skill in the art will appreciate that biometric sensor 640 may include any suitable biometric sensing device. Biometric sensor 640 facilitates identifying and/or authenticating a user of token storage device 620, as described herein.

In the example embodiment, embedded microchip 630 is configured to securely store one or more received payment tokens 622 and communicate token(s) 622 to a merchant POS terminal 624, such as POS terminals 302 and 304 (shown in FIG. 3) as payment during a payment transaction at a merchant location. In some embodiments, microchip 630 is configured to provide an additional layer of security by encrypting payment token(s) 622. In these embodiments, microchip 630 stores encrypted payment token(s) 622 in memory 634, and transmits encrypted payment token(s) 622 to a merchant POS terminal, such as POS terminals 302 and 304 when a user initiates a payment transaction at the merchant location.

Token storage device 620 may be activated for use, for example, similar to the activation of token storage device 102 described in connection with FIG. 1 (i.e., with a user submitting a token request to the TM server, the TM server generating a token and transmitting the token in a token response message to a user computing device, and the user computing device loading the token onto token storage device 620). Further, one or more token(s) 622 stored on token storage device 620 may be used to conduct a purchase transaction through a payment card processing network, similar to the process described in connection with FIGS. 2 and 3 (i.e., including communicating token(s) 622 to a merchant device and processing authorization request and response messages as described in connection with FIG. 2).

Notably, TM computing system 600 enables multiple users (e.g., first and second users 602 and 604) to activate and configure token storage device 620 for use in conducting one or more purchase transactions. Although multiple specific embodiments including multiple users using token storage device 620 are described herein, those of skill in the art will appreciate that other embodiments are within the spirit and scope of this disclosure.

In one embodiment, token storage device 620 stores a token 622 that includes prepaid funds from multiple users (e.g., first and second users 602 and 604). This allows the multiple users to each contribute to a total spending limit loaded onto token 622. For example, two users may plan on attending an event (e.g., a concert) together or taking a trip together, and may both want to conduct one or more purchase transactions at the event or trip using token storage device 620 (with the total spending limit loaded onto token 622).

For example, first user 602 may submit (e.g., using app 616 on first user computing device 606) a first token request to the TM server that includes a first PAN (associated with a first payment account of first user 602) and a first amount of funds. In response, the TM server generates token 622 with a first spend limit (corresponding to the first amount of funds) loaded onto token 622.

Then, first user 602 may invite second user 604 to increase the spend limit loaded onto token 622. For example, first user 602 (e.g., using app 616 on first user computing device 606), can instruct the TM server to prompt second user 604 (e.g., via app 616 on second user computing device 608) to increase the spend limit loaded onto token 622. In response to the prompt, using app 616 on second user computing device 608, second user 604 transmits a second PAN (associated with a payment account of second user 604) and a second amount of funds to TM server. In response, the TM server adds a second spend limit (corresponding to the second amount of funds) to the first limit, such that token 622 is loaded with a cumulative spend limit corresponding to the sum of the first and second spend limits. Then, token 622 may be transmitted to first or second user computing device 606 and 608, and loaded (from first or second user computing device 606 and 608) onto token storage device 620.

Once token 622 is loaded onto token storage device 620, subject to controls established on token 622 (e.g., the cumulative spend limit), first and second users 602 and 604 can each use token storage device 620 to conduct purchase transactions. Purchase transactions may be processed similar to the purchase transaction discussed in connection with FIG. 2.

In this embodiment, while processing purchase transactions, the TM server is configured to translate token 622 to both the first payment account and the second payment account. For example, the TM server may translate token 622 to the first payment account until the first spend limit is reached. At that point, the TM server may switch to translating token 622 to the second payment account until the second spend limit is reached (and thus the cumulative spend limit is reached). Alternatively, the TM server may translate token 622 using other suitable schemes (e.g., alternating between using the first payment account and the second payment account for each purchase transaction).

For example, biometric sensor 640 may be used to determine which payment account token 622 should be translated to by the TM server. In this example, if first user 602 uses token storage device 620 for a purchase transaction, first user 602 inputs biometric information into biometric sensor 640, and token storage device 620 determines, from the received biometric information, that first user 602 is conducting the purchase transaction (e.g., by comparing the received biometric information to baseline biometric information stored on token storage device 620). Then, when token storage device 620 transmits token 622 to merchant POS terminal 624, token storage device 620 includes a flag (or other suitable indicator) in token 622 to instruct the TM server to translate token 622 to the first payment account.

In other examples, token storage device 622 may determine which user 602 and 604 is operating token storage device 622 (and accordingly, which of first and second payment accounts should be used) based on geofencing and/or proximity of users 602 and 604 to token storage device 622. For example, token storage device 622 may determine, based on communication with first and second user computing devices 606 and 608, a proximity of each user computing device 606 and 608 to token storage device 622. From this, token storage device 622 determines that the user associated with user computing device 606 or 608 closest to token storage device 622 is the user conducing the purchase transaction. Then, when token storage device 620 transmits token 622 to merchant POS terminal 624, token storage device 620 includes a flag (or other suitable indicator) in token 622 to instruct the TM server to translate token 622 to the payment account associated with that user. Those of skill in the art will appreciate that these are only examples, and other suitable methods may be used to determine which payment account token 622 should be translated to.

In another embodiment, instead of token 622 being associated with multiple payment accounts, token 622 is associated with a single payment account shared by multiple users. For example, first and second users 602 and 604 may establish a shared payment account (e.g., through an issuing bank), and each contribute funds to the shared payment account. To activate token storage device 620, one of first and second users 602 and 604 submits a token request to the TM server with a PAN identifying the shared payment account. In response, the TM server generates token 622 associated with the received PAN, and transmits token 622 to one or both of first and second user computing devices 606 and 608 for loading onto token storage device 620. When processing purchase transactions, the TM server is configured to translate token 622 to the shared payment account.

In yet another embodiment, instead of token 622 being associated with one or more payment accounts, funds may be directly loaded onto token 622 (and thus token storage device 620). For example, using first user computing device 606, first user 602 may electronically transfer first funds from a first payment account onto token 622. Similarly, second user 604, using second user computing device 608, may electronically transfer second funds from a second payment account onto token 622. Token 622 then includes cumulative funds equal to the sum of the first and second funds, and token storage device 620 can be used to perform (subject to other limitations on token 622) purchase transactions until the funds are depleted. In this example, when purchase transactions are performed, instead of token 622 being mapped to a payment account by the TM server, the appropriate funds are simply electronically transferred from token 622 to a merchant computing device (e.g., merchant POS terminal 624). Thus, token storage device 620 effectively functions as a “prepaid” device.

As noted above, in some embodiments, token storage device 620 includes biometric sensor 640 for identifying and authenticating users (e.g., first and second users 602 and 604). For example, during an enrollment process for token storage device 620, first and second users 602 and 604 may provide baseline biometric data 650 (e.g., a fingerprint) to token storage device 622. In one example, baseline biometric data 650 is provided directly from users 602 and 604 to token storage device 620 by users 602 and 604 inputting baseline biometric data 650 into token storage device 622 via biometric sensor 640. In another example, baseline biometric data 650 is transmitted from user computing devices 606 to token storage device 622. Baseline biometric data 650 is then stored in memory 634.

During a purchase transaction, baseline biometric data 650 may be used to identify and authenticate the person attempting to use token storage device 620 (i.e., a candidate user). For example, the candidate user may provide candidate biometric data 652 (e.g., a fingerprint) to token storage device 622 (e.g., via biometric sensor 640 or through an associated user computing device), and token storage device 620 compares candidate biometric data 652 to the stored baseline biometric data 650. If candidate biometric data 652 matches baseline biometric data 650, token storage device 620 identifies and authenticates the candidate user as one of users 602 and 604, and allows the purchase transaction to proceed.

In some embodiments, baseline biometric data 650 may be stored on token storage device 620 in association with an expiration date (e.g., one week from when baseline biometric data 650 was collected). The expiration date may be a default value and/or a user-specified value. Once the expiration data is reached, token storage device 620 no longer allows purchase transactions for users with candidate biometric data 652 matching baseline biometric data 650. That is, a user may only be authorized to use token storage device 620 for a temporary time period (i.e., until the expiration date). In this way, one user who actually owns token storage device 620 may allow other users to temporarily use token storage device 620 (e.g., for the duration of a trip or event).

In another example, when a purchase transaction is attempted using token storage device 620, token storage device 620 sends an authentication request message 660 to one or more user computing devices associated with authorized users of token storage device 620 (e.g., user computing devices 606 and 608 of first and second users 602 and 604). Upon receiving authentication request message 660, the user computing device may prompt the associated user to confirm that the attempted purchase transaction is legitimate (e.g., by entering a PIN code or other authentication information on the user computing device). If the user confirms the attempted purchase transaction is legitimate, the user computing device returns an authentication response message 662 to token storage device 620, and token storage device 620 allows the purchase transaction to proceed.

Those of skill in the art will appreciate that the authentication processes described herein are examples, and that other suitable authentication schemes may be used with the systems described herein.

In another embodiment involving multiple users, multiple tokens 622 are stored on token storage device 620, with each token 622 associated with a different user (e.g., first and second users 602 and 604). For example, token storage device 620 may include a first token that is linked to a first payment account of first user 602, and a second token that is linked to a second payment account of second user 604. These first and second tokens may be generated and loaded onto token storage device 620 using processes substantially similar to those described in connection with FIG. 1. Further, each token 622 may include user identification data (e.g., biometric information, a PIN code, etc.) that identifies the user associated with that token (and the corresponding payment account that is linked to that token). Accordingly, when multiple tokens are stored on token storage device 620, multiple sets of user identification data are also stored on token storage device 620.

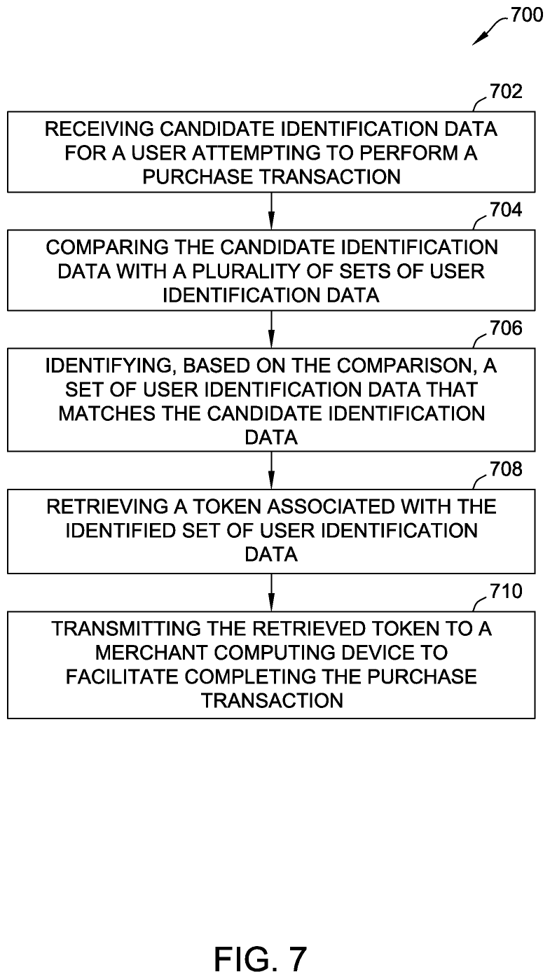

During a purchase transaction, token storage device 620 is capable of dynamically switching between using the first and second tokens based on which user is using token storage device 620 for the purchase transaction. For example, FIG. 7 is a flow diagram of one embodiment of a method 700 for dynamically switching between tokens. Method 700 is performed, for example, by a token storage device (e.g., token storage device 620) upon the initiation of a purchase transaction.

As shown in FIG. 7, the token storage device receives 702 candidate identification data for a user attempting to perform the purchase transaction. The candidate identification data may be received 702 at the token storage device from a user computing device (e.g., first and second user computing devices 606 and 608) or directly from a user (e.g., via biometric sensor 640).

Upon receiving 702 the candidate identification data, the token storage device compares 704 the candidate identification data with a plurality of sets of user identification data stored on the token storage device. Based on the comparison, the token storage device identifies 706 a set of user identification data that matches the candidate identification data.

Subsequently, the token storage devices retrieves 708, from the memory of the token storage device, a token associated with the identified 706 set of user identification data, and transmits 710 the retrieved 708 token to a merchant computing device (e.g., a merchant POS device) to facilitate completing the purchase transaction.

Accordingly, the token storage device is capable of dynamically switching which token is used for a given purchase transaction based on which user is attempting to use the token storage device at that point in time.

In yet another embodiment involving multiple users, token 622 stored on token storage device 620 is associated with a plurality of virtual budget accounts, each virtual budget account associated with a different user (e.g., first and second users 602 and 604). This enables tracking spending budgets for each user over the duration of a trip or event, and facilitates settling up between users after the conclusion of the trip or event, as described herein.

In one example of this embodiment, token 622 is linked to a single payment account (also referred to herein as a combined payment account) and loaded onto token storage device 620. The combined payment account may include funds supplied from one or more users (e.g., first and second users 602 and 604). During purchase transactions conducted using token storage device 620, token 622 is mapped to the combined payment account (e.g., by the TM server) and appropriate funds are debited from the combined payment account to complete the purchase transactions.

In this embodiment, however, a plurality of virtual budget accounts are also generated and stored on token 622 (and thus on token storage device 620). Each virtual budget account is associated with one of the users, and tracks the spending for that user for purchase transactions conducted using token storage device 620. Once all purchase transactions are completed (e.g., at the end of an event or trip), the virtual budget accounts are used to determine if some users owe other users funds (due to their purchases using the combined payment account).

For example, assume that combined payment account includes $700 supplied by first user 602 and $500 supplied by second user 604 (for $1200 total in combined payment account), and token 622 is generated and linked to that combined payment account, and stored on token storage device 620.

Using first and second user computing devices 606 and 608, each user 602 then sets an expected budget for purchases made using token storage device 620. For example, first user 602 may set an expected budget of $700 (corresponding to the $700 in funds supplied by first user 602) and second user 604 may set an expected budget of $500 (corresponding to the $500 in funds supplied by second user 604). Although the expected budgets match the funds contributed in this example, that need not be the case.

In one embodiment, a user that owns token storage device 620 and/or the combined payment account may invite the other users (e.g., by causing an electronic invite to be sent to the user computing devices of those users) to set their respective expected budgets and to link into token storage device 620 (e.g., via a PIN code). Alternatively, users may set their expected budgets using other suitable processes.

A user may invite additional users using any suitable method. For example, first user 602 may tap first user computing device 606 against second user computing device 608 to invite second user 604 (e.g., using NFC communications between first and second user computing devices 606 and 608). In another example, second user 604 may operate second user computing device 608 to scan a QR code (or other optical information) displayed on first user computing device 606 to receive an invite.

In yet another example, first user 602 may use a list of known contacts (e.g., friends) stored on first user computing device 606 to select and electronically invite other users to join. The selected users may receive a notification and/or link on their respective user computing device that invites them. In yet another example, first user 602 may operate first user computing device 606 to broadcast a signal (e.g., Bluetooth) so that known contacts within a particular geo-fence are invited to join when their user computing devices receive the signal. Notably, these examples advantageously prevent users 602 and 604 from having to manually exchange information.

Once a user sets at expected budget, a corresponding virtual budget account is generated and stored on token storage device 620 in association with token 622. Accordingly, in the above example, a first virtual budget account indicating an expected budget of $700 for first user 602 is generated and stored on token storage device 620, and a second virtual budget account indicating an expected budget of $500 for second user 604 is generated and stored on token storage device 620. Each virtual budget account also includes user identification data (e.g., biometric information, a PIN code, etc.) that identifies the user associated with that virtual budget account, and an actual budget representing the actual funds spent by that user on one or more purchase transactions using token storage device 620 (discussed in further detail below).

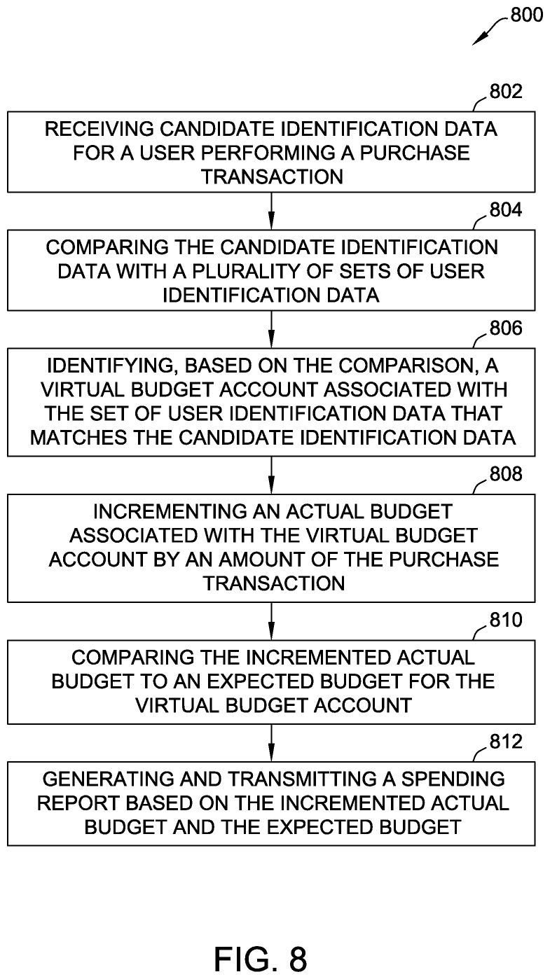

During a purchase transaction, token storage device 620 is capable of tracking funds spent from the combined payment account against the virtual budget account of the user conducting the purchase transaction. For example, FIG. 8 is a flow diagram of one embodiment of method 800 for tracking funds spent from a combined payment account against a virtual budget account. Method 800 is performed, for example, by a token storage device (e.g., token storage device 620) upon the initiation of a purchase transaction.

As shown in FIG. 8, the token storage device receives 802 candidate identification data for a user performing the purchase transaction. The candidate identification data may be received at the token storage device from a user computing device (e.g., first and second user computing devices 606 and 608) or directly from a user (e.g., via biometric sensor 640).

Upon receiving the candidate identification data, the token storage device compares 804 the candidate identification data with a plurality of sets of user identification data stored on the token storage device (each set of user identification data included within a corresponding virtual budget account). Based on the comparison, the token storage device identifies 806 a virtual budget account including the set of user identification data that matches the candidate identification data. Subsequently, the token storage devices increments 808 an actual budget associated with the virtual budget account by an amount of the purchase transaction.

Before any purchase transactions are conducted, the actual budget on each virtual budget account is zero. However, as purchase transactions are conducted, the actual budgets are incremented for each user in accordance with the purchases made by each user.

Once the actual budget is incremented 808, the token storage device compares 810 the actual budget to the expected budget for that virtual budget account. In some embodiments, if the incremented actual budget is greater than the expected budget (i.e., indicating that the user has attempted to spend more than the expected budget previously established), the token storage device may prohibit the transaction and/or transmit one or more notification messages to the user computing devices.

For example, the token storage device may transmit a first notification message to the user associated with the virtual budget account, notifying that particular user that the purchase transaction, if completed, will cause the actual budget to exceed the expected budget. Further, the first notification message may prompt the user to add additional funds to the combined payment account (e.g., via their user computing device) to cover the additional spending.

As another example, the token storage device may transmit a second notification message to a second user (e.g., another user authorized to use the token storage device, but not the first user conducting this particular transaction). In some embodiments, the second notification message prompts the second user to i) authorize the first user to exceed the first user's expected budget (i.e., using funds in the combined payment account that exceed the first user's expected budget) or ii) prohibit the first user from exceeding the first user's expected budget. In this way, users are able to monitor and (to an extent) control other users' use of the combined payment account via the token storage device.

In the example embodiment, the token storage device generates and transmits 812 a spending report based at least in part on the incremented actual budget and the expected budget. The spending report may be transmitted 812 to one or more of the user computing devices associated with the multiple users authorized to use the token storage device The spending report may specify, for example, the actual budget and expected budget for one or more of the virtual budget accounts stored on the token storage device.

In one example, the spending report is generated and transmitted 812 after the event or trip has concluded (for example, the spending report may be generated when an expiration date associated with the token is reached). This enables the users to see how much each user has spent against their expected budget, and enables a given user to determine whether they owe money to one or more other users in the group (e.g., if that given user's actual budget exceeds their expected budget) or whether they are owed money by one or more other users in the group (e.g., if the one or more other users' actual budgets exceed their expected budget). In another example, the spending report is generated and transmitted 812 in response to a user requesting the spending report (e.g., using their user computing device).

As will be appreciated based on the foregoing specification, the above-described examples of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed examples of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

For example, one or more computer-readable storage media may include computer-executable instructions embodied thereon for generating a secure payment token for use at a physical merchant location using a token storage device, such as token storage device 102 (shown in FIG. 1). In this example, the server (e.g., computing device) may include a memory device and a processor in communication with the memory device, and when executed by said processor the computer-executable instructions may cause the processor to generate a secure payment token in response to receiving a token request from a user computing device, and transmit the secure payment token to the user computing device, thereby instructing the user computing device to transfer the secure payment token onto a token storage device for use at a physical merchant location, as illustrated in FIGS. 1-3.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

This written description uses examples to describe embodiments of the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A token management computing system for provisioning at least one secure payment token for use in payment transactions, the token management computing system comprising:
a token storage device configured to communicate a payment token to a merchant point-of-sale terminal, wherein the token storage device is in communication with a plurality of user computing devices each associated with a respective user; and
a token management (“TM”) server comprising:
a memory device for storing data; and
at least one processor communicatively coupled to the memory device, the at least one processor programmed to:
receive, from at least one of the user computing devices, a token request for at least one token;
generate, upon receiving the token request, the at least one token, wherein the at least one token includes at least one of i) a prepaid token including prepaid funds from the plurality of users, ii) multiple tokens each associated with a different user of the plurality of users, and iii) a budgeting token associated with a plurality of virtual budget accounts corresponding to the plurality of different users;
transmit the at least one generated token to one or more of the user computing devices; and
instruct the one or more of the user computing devices to transfer the at least one token to the token storage device for use at a physical merchant location.

2. The token management computing system of claim 1, wherein the token storage device comprises a biometric sensor.

3. The token management computing system of claim 1, wherein the at least one token includes the prepaid token, and wherein the TM server is configured to:
electronically transfer first funds from a first payment account associated with a first user of the plurality of users onto the prepaid token; and
electronically transfer second funds from a second payment account associated with a second user of the plurality of users onto the prepaid token such that the prepaid token includes a sum of the first and second funds.

4. The token management computing system of claim 1, wherein the at least one token includes the multiple tokens, wherein each of the multiple tokens includes an associated set of user identification data, and wherein the token storage device is configured to:
receive candidate identification data associated with a purchase transaction;
compare the candidate identification data with the plurality of sets of user identification data;
identify, based on the comparison, a set of user identification data that matches the candidate identification data;
retrieve a token associated with the identified set of user identification data; and
transmit the retrieved token to the merchant point-of-sale terminal to facilitate completing the purchase transaction.

5. The token management computing system of claim 4, wherein the token storage device is configured to receive the candidate identification data via a biometric sensor on the token storage device.

6. The token management computing system of claim 4, wherein the token storage device is configured to receive the candidate identification data from a candidate user computing device.

7. The token management computing system of claim 1, wherein the at least one token includes the budgeting token, wherein each virtual budget account associated with the budgeting token includes an associated set of user identification data, and wherein the token storage device is configured to:
receive candidate identification data associated with a purchase transaction;
compare the candidate identification data with the plurality of sets of user identification data;
identify, based on the comparison, a virtual budget account associated with a set of user identification data that matches the candidate identification data; and
increment an actual budget associated with the identified virtual budget account by an amount of the purchase transaction.

8. The token management computing system of claim 7, wherein the token storage device is further configured to:
compare the incremented actual budget to an expected budget for the identified virtual budget account.

9. The token management computing system of claim 8, wherein the token storage device is further configured to:
generate a spending report based at least in part on the incremented actual budget and the expected budget; and
transmit the spending report to at least one of the user computing devices.

10. The token management computing system of claim 8, wherein the token storage device is configured to:
generate a notification message based on the comparison of the incremented actual budget to the expected budget; and
transmit the notification message to at least one of the user computing devices.

11. A token storage device for communicating a payment token to a merchant point-of-sale terminal, the token storage device comprising:
a memory device; and
at least one processor communicatively coupled to the memory device, the at least one processor programmed to:
receive at least one token from at least one user computing device of a plurality of user computing devices each associated with a respective user, wherein the at least one token is generated by a token management (“TM”) server, and wherein the at least one token includes at least one of i) a prepaid token including prepaid funds from the plurality of users, ii) multiple tokens each associated with a different user of the plurality of users, and iii) a budgeting token associated with a plurality of virtual budget accounts corresponding to the plurality of different users;
store the at least one received token in the memory; and
transmit the at least one received token to the merchant point-of-sale terminal to facilitate completing a purchase transaction.

12. The token storage device of claim 11, further comprising a biometric sensor.

13. The token storage device of claim 11, wherein the at least one token includes the prepaid token, and the prepaid token includes i) first funds electronically transferred from a first payment account associated with a first user of the plurality of users onto the prepaid token, and ii) second funds electronically transferred from a second payment account associated with a second user of the plurality of users onto the prepaid token.

14. The token storage device of claim 11, wherein the at least one token includes the multiple tokens, wherein each of the multiple tokens includes an associated set of user identification data, and wherein the token storage device is configured to:
receive candidate identification data associated with the purchase transaction;
compare the candidate identification data with the plurality of sets of user identification data;
identify, based on the comparison, a set of user identification data that matches the candidate identification data;
retrieve a token associated with the identified set of user identification data; and
transmit the retrieved token to the merchant point-of-sale device to facilitate completing the purchase transaction.

15. The token storage device of claim 14, wherein the token storage device is configured to receive the candidate identification data via a biometric sensor on the token storage device.

16. The token storage device of claim 14, wherein the token storage device is configured to receive the candidate identification data from a candidate user computing device.

17. The token storage device of claim 11, wherein the at least one token includes the budgeting token, wherein each virtual budget account associated with the budgeting token includes an associated set of user identification data, and wherein the token storage device is configured to:
receive candidate identification data associated with the purchase transaction;
compare the candidate identification data with the plurality of sets of user identification data;
identify, based on the comparison, a virtual budget account associated with a set of user identification data that matches the candidate identification data; and
increment an actual budget associated with the identified virtual budget account by an amount of the purchase transaction.

18. The token storage device of claim 17, wherein the token storage device is further configured to:
compare the incremented actual budget to an expected budget for the identified virtual budget account.

19. The token storage device of claim 18, wherein the token storage device is further configured to:
generate a spending report based at least in part on the incremented actual budget and the expected budget; and
transmit the spending report to at least one of the user computing devices.

20. The token storage device of claim 18, wherein the token storage device is configured to:
generate a notification message based on the comparison of the incremented actual budget to the expected budget; and
transmit the notification message to at least one of the user computing devices.
